(19) United States
(12) Patent Application Publication
(10) Pub. No.: US 2014/0157415 A1
(43) Pub. Date: Jun. 5, 2014

(54) INFORMATION SECURITY ANALYSIS USING GAME THEORY AND SIMULATION

(71) Applicant: UT-Battelle, LLC, Oak Ridge, TN (US)

(72) Inventors: Robert K. Abercrombie, Knoxville, TN (US); Bob G. Schlicher, Knoxville, TN (US)

(21) Appl. No.: 14/097,840

(22) Filed: Dec. 5, 2013

Related U.S. Application Data
(60) Provisional application No. 61/733,577, filed on Dec. 5, 2012.

(51) Int. Cl. G06F 21/56

(52) U.S. Cl. CPC G06F 21/56
USPC 726/23

(57) ABSTRACT

Vulnerability in security of an information system is quantitatively predicted. The information system may receive malicious actions against its security and may receive corrective actions for restoring the security. A game oriented agent based model is constructed in a simulator application. The game ABM model represents security activity in the information system. The game ABM model has two opposing participants including an attacker and a defender, probabilistic game rules and allowable game states. A specified number of simulations are run and a probabilistic number of the plurality of allowable game states are reached in each simulation run. The probability of reaching a specified game state is unknown prior to running each simulation. Data generated during the game states is collected to determine a probability of one or more aspects of security in the information system.

### RELATED PATENTS AND APPLICATIONS

This patent application makes reference to and claims priority to U.S. Provisional Patent Application Ser. No. 61/733,577, filed on Dec. 5, 2012, which is hereby incorporated herein by reference in its entirety.

### STATEMENT REGARDING FEDERALLY FUNDED RESEARCH AND DEVELOPMENT

This invention was made with government support under Contract No. DE-AC05-00OR22725 between UT-Battelle, LLC and the U.S. Department of Energy. The government has certain rights in the invention.

### BACKGROUND OF THE INVENTION

1. Technical Field

The present disclosure relates to analysis of information security and more specifically to using game theory and simulation for analysis of information security.

2. Related Art

Today's security systems, economic systems and industrial systems depend on the security of myriad devices and networks that connect them and that operate in ever changing threat environments. Adversaries apply increasingly sophisticated methods to exploit flaws in software, telecommunication protocols, and operating systems. The adversaries infiltrate, exploit, and sabotage weapon systems, command, control and communications capabilities, economic infrastructure and vulnerable control systems. Furthermore, sensitive data may be exfiltrated to obtain control of networked systems and to prepare and execute attacks. Information security continues to evolve in response to disruptive changes with a persistent focus on information-centric controls.

Security may comprise a degree of resistance to harm or protection from harm and may apply to any asset or system, for example, a person, an organization, a nation, a natural entity, a structure, a computer system, a network of devices or computer software. Security may provide a form of protection from, or response to a threat, where in some instances, a separation may be created between the asset and the threat. Information security may provide means of protecting information and information systems from unauthorized access, use, disclosure, disruption, modification, or destruction.

### BRIEF SUMMARY OF THE INVENTION

A computer implemented method is defined for quantitatively predicting vulnerability in the security of an information system. The information system may be operable to receive malicious actions against the security of the information system and may be operable to receive corrective actions relative to the malicious actions for restoring security in the information system. For the information system, a game oriented agent based model may be constructed in a simulator application. The constructed game oriented agent based model may represent security activity in the information system. Moreover, the game oriented agent based model may be constructed as a game having two opposing participants including an attacker and a defender, a plurality of probabilistic game rules and a plurality of allowable game states. The simulator application may be run for a specified number of simulation runs and may reach a probabilistic number of the plurality of allowable game states in each of the simulation runs. The probability of reaching a specified one or more of the plurality of allowable game states may be unknown prior to running each of the simulation runs. Data which may be generated during the plurality of allowable game states may be collected to determine a probability of one or more aspects of the security in the information system.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. Non-limiting and non-exhaustive descriptions are described with reference to the following drawings. The components in the figures are not necessarily to scale, emphasis instead being placed upon illustrating the principles of the invention. Moreover, in the figures, like referenced numerals designate corresponding parts throughout the different views.

FIG. 1 illustrates an exemplary information system comprising an enterprise topology and two participants that may take opposing actions with respect to the enterprise system, where participant actions and evolving states of the system may be represented in a game construct and analyzed using agent based model simulations.

FIG. 2 illustrates an exemplary computer system that may be utilized to analyze security in an information system by modeling the information system as a game construct in an agent based model simulation.

FIG. 3 is a flow chart comprising exemplary steps for configuring a simulator to virtualize an information system as a game construct utilizing an agent based model.

FIG. 4 is a flow chart comprising exemplary steps for executing a game model simulation representing active participants in an information system, to measure vulnerability probabilities of a real information system.

FIG. 5 is a chart of probabilities of successful attacks based on output from a game model simulation representing active participants in an information system.

FIG. 6 is a chart of cumulative distribution of probabilities for successful attacks based on the same game model simulation output utilized in the chart shown in FIG. 5.

FIG. 7 is a chart depicting probability of confidentiality in an enterprise system based on output from a game model simulation representing active participants in an information system.

FIG. 8 is a chart depicting probability of integrity in an enterprise system based on output from a game model simulation representing active participants in an information system.

FIG. 9 is a chart depicting probability of availability in an enterprise system based on output from a game model simulation representing active participants in an information system.

### DETAILED DESCRIPTION OF THE PREFERRED EMBODIMENTS

A method and system is presented that models competition in a framework of contests, strategies, and analytics and provides mathematical tools and models for investigating multi-player strategic decision making in a real or realistic information system. A strategic, decision making game model of conflict between decision-makers acting in the real or realistic information system is constructed and agent based model simulations are run based on the constructed game model, to analyze security issues of the real or realistic information system. In this manner, the agent based model simulations may re-create or predict complex phenomena in the real or realistic information system under consideration, where security of the system may be threatened and/or breached by an attacker and the security may be enforced and/or recovered by a defender. The realistic information system may refer to a hypothetical or planned information system.

The information or the information system under consideration may be referred to as an asset, an information asset, an enterprise network, enterprise system or a system, for example, and may comprise one or more elements of a system for computing and/or communication. For example, the information or the information system under consideration may comprise one or more of computer systems, communication infrastructure, computer networks, personal computer devices, communication devices, stored and/or communicated data, signal transmissions, software instructions, system security, a Website, a display of information, a communication interface or any suitable logic, circuitry, interface and/or code. The information system may be deployed in various environments, for example, critical infrastructure, such as cyber defense, nuclear power plants, laboratories, business systems, communications systems, government and military complexes or air and space systems. Moreover, the information system may extend to or include remote or mobile systems such as robots, bio systems, or land, air, sea or space crafts, for example.

In reality, a network administrator or “defender” often faces a dynamic situation with incomplete and imperfect information against an attacker. The present approach considers a realistic attack scenario based on imperfect information. For example, the defender may not always be able to detect attacks. The probabilities of attack detection, player decisions and/or success of an action may change over time as simulations proceed, for example. This present approach provides an improvement over other approaches using stochastic game models. In this present approach, state transition probabilities may not be fixed before a game starts. These probabilities may not be computed merely from domain knowledge and past statistics alone. Moreover, this approach is not limited to synchronous player actions. In this regard, the probability of a particular state occurring in an information asset or how many times a particular state may occur, may not be known prior to running the ABM simulations. Furthermore, this approach may provide the advantage of being scalable in relation to the size and/or complexity of an information system under consideration.

A mathematical tool and a model for investigating multiplayer, strategic decision making is described herein, where a game construct may be modeled in an agent based model (ABM) simulator and ABM simulations may be executed to analyze the security of a realistic information asset. The game based, agent-based model may comprise a computational model where actions and/or interactions by participants are simulated in one or more game scenarios. Each iteration or instance of the ABM simulation may be referred to as a simulation run, a scenario, a play or a game, for example, and may comprise one or more actions taken or not taken by one or more of the participants over the time period of the simulation. In some embodiments, the participants may comprise an attacker and a defender of the information assets. An example of a defender may be a human system administrator that protects an information system from attacks by a malicious attacker or hacker. An example of an attacker may include a hacker or any participant that may gain access to information or an information system, by any available means and performs malicious acts that may, for example, steal, alter, or destroy all or a portion of the system or information therein. However, the methods and systems described herein are not limited with regard to any specific type of participant and any suitable participant may be utilized or considered. The participants may or may not be human, and may or may not include automated systems or software processes, for example. Furthermore, in addition to cyber-attacks on an information asset, the attacks may include physical attacks or damage to equipment of the information system. Each participant may behave as an autonomous agent in the ABM simulations and may be referred to as an attacker, a defender, an adversary, an opponent, an active component, an agent or a player, for example.

Each action which may be taken by a participant during a simulation may be associated with a probability that the participant will take the action, P(a) and another probability for success of the action in instances when the action was taken, P(s). The agent based model may be configured with a plurality of states representing changing conditions of an information asset that may occur over time as the participants take actions and the ABM simulations advance. Each successful action taken by a participant, for example, may cause the state of the modeled information asset or game to change from one state to another state in a probabilistic manner based on probabilistic rules constructed in the agent based model simulation.

Each ABM simulated scenario may represent an enactment of probabilistic offensive and/or probabilistic defensive actions applied to in an information asset by opposing participants. Results from a sequence of the ABM simulated scenarios may enable assessment of how the actions and/or interactions by scenario participants affect one or more aspects of security of the information asset over time. In this regard, the game oriented ABM simulations may provide quantitative measures of the probability of various security issues. For example, the ABM simulations may measure the probability of confidentiality, integrity and/or availability of one or more information assets. In another example, the ABM simulations may measure the probability that an attack on an information asset will be successful. The quantitative measures that are output from the simulations may depend on the probabilities of the various player actions, the probabilities of success of the various player actions when they are taken, and the effects or payoffs relative to the player's actions during a game, for example.

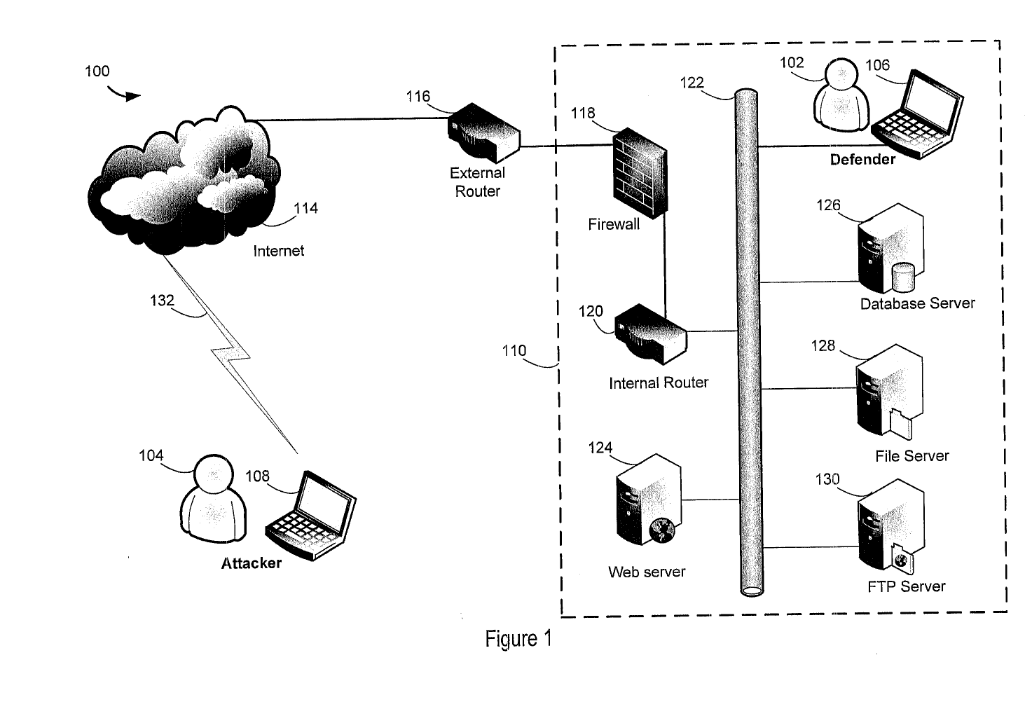

Now turning to the figures, FIG. 1 illustrates an exemplary information system comprising an enterprise network topology and two participants that may take opposing actions with respect to the enterprise system, where the participants' actions and probabilistic game states of the system may be identified in a game construct and analyzed using agent based model simulations. FIG. 1 comprises a system 100 which may include an enterprise network 110. The enterprise network 110 may comprise various entities including a database server 126, a fileserver 128, a file transfer protocol (FTP) server 130, a Webserver 124, an internal router 120, a firewall 118 and an enterprise communication link 122. The enterprise network 110 may be referred to as a system and the various entities in the enterprise network 110 may be referred to as resources. Also included in the information system 100 are an external router 116, a network 114 and a wireless communication link 132. Also shown in the information system 100 are a defender 102, a terminal 106, an attacker 104 and a terminal 108.

The various entities included in the enterprise network 110 may be communicatively coupled via the enterprise communication link 122 which may comprise a local area network, for example. The various entities in the enterprise network 110 may be communicatively coupled to the network 114 via the external router 116. The network 114 may comprise any suitable network and may include, for example, the Internet. The network 114 may be referred to as the Internet 114. The enterprise network 110 may include the database server 126 which may have access to storage devices and may comprise a computer running a program that is operable to provide database services to other computer programs or other computers, for example, according to a client-server model. The fileserver 128 may comprise a computer and/or software that provides shared disk access for storage of computer files, for example, documents, sound files, photographs, movies, images or databases that can be accessed by a terminal device or workstation that is communicatively coupled to the enterprise network 110. The FTP server 130 may comprise a computer configured for transferring files using the File Transfer Protocol using a client-server model, for example. The files may be transferred to or from a device which may include an FTP client. The Webserver 124 may comprise a computer and/or software that are operable to deliver Web content via the enterprise network 110 and/or the network 114 to a client device. The Webserver 124 may host Websites or may be utilized for running enterprise applications. The internal router 120 and the external router 116 may be operable to forward data packets between the enterprise network 110 and the network 114. The internal router 120 and external router 116 may be connected to data lines from various networks. The internal router 120 and external router 116 may read address information in the data packets to determine packet destinations. Using information in a routing table or routing policy, the internal router 120 may direct packets to the external router 116 and vice versa. The enterprise network 110 may include in the firewall 118 which may comprise a software and/or hardware based network security system that may control incoming and outgoing enterprise network 110 traffic. The firewall 118 may analyze data packets and determine whether they should be allowed through to the enterprise network 110 based on applied rule set. The firewall 118 may establish a barrier between the trusted, secure internal enterprise network 110 and other networks such as the network 114 that may comprise the Internet.

The various entities in the enterprise network 110 may be accessed by various terminals, for example, any suitable computing and/or communication device such as a work station, a laptop computer or a wireless device that may be communicatively coupled within the enterprise network 110 or may be external to the network. Access to the enterprise network 110 and/or the various entities in the enterprise network 110 may be protected by various suitable security mechanisms. For example, security applications may require authentication of credentials such as account names and passwords of users attempting to access the enterprise network 110 servers 124, 126, 128 and/or 130. When a client submits a valid set of credentials it may receive a cryptographic ticket that may subsequently be used to access various services in the enterprise network 110. Authentication software may provide authorization for privileges that may be granted to a particular user or to a computer process and may enable secure communication in the enterprise network 110.

The attacker 104 may comprise a person and/or a computer process, for example, that may gain or attempt to gain unauthorized access to the enterprise network 110 and/or the various entities in the enterprise network 110 utilizing the terminal device 108, for example. The attacker 104 may be referred to as a hacker and may destroy or steal information, prevent access by others or impair or halt various functions and operations in the enterprise network 110. The attacker may or may not take unauthorized actions in the enterprise system 110 and different results may occur depending on whether the attacker attempts or takes the unauthorized actions and depending on whether the action is successful. The terminal 108 may comprise any suitable computing and/or communication device, for example, a laptop, mobile phone, personal computer that may be communicatively coupled to the enterprise network 110 via any suitable one or more communication links. In one example, the terminal 108 may be communicatively coupled to the enterprise network 110 via the wireless link 132 and the internet 114.

The defender 102 may comprise a person and/or a computer process, for example, that may defend the various entities in the enterprise network 110 against attacks by the attacker 104 utilizing the terminal device 106. In some systems, the defender 102 may be a system administrator that may configure, maintain and/or manage one or more of the various entities in the enterprise network 110 utilizing the terminal device 106. The defender 102 may or may not detect actions taken by the attacker 104. Furthermore, the defender 102 may or may not take actions to counter the effects of the attacker 104's actions in the enterprise system 110. Different results may occur depending on whether the defender 102 detects the attacker 104's actions and/or depending on whether the defender is successful in countering the attacker 104's actions. Although the defender 102 is described as a person, the system is not limited in this regard and the defender 102 may be any suitable hardware device and/or software process that may be operable to defend the enterprise system from the effects of the attacker 104. The terminal 108 may comprise any suitable computing and/or communication device, for example, a laptop, mobile phone, personal computer or workstation that may be communicatively coupled to the enterprise network 110 via any suitable one or more communication links for example, any local or remote wireless, wire-line or optical communication link.

In one exemplary operation, the attacker 104 may attack the enterprise network 110 or one or of the various entities in the enterprise network 110. For example, the attacker 104 may attempt to attack or may continue to attack a Hypertext Transfer Protocol Daemon (HTTPD or HTTP daemon) process that may be running in the Webserver 124. The HTTP daemon may comprise a software program that may run in the background of the Webserver 124 and may wait for incoming server requests. The HTTP daemon may answer the requests and may serve hypertext and multimedia documents over the Internet 114 using HTTP. In some instances, the attacker may compromise an account or hack the HTTPD system such that the HTTPD system may be impaired or destroyed. The defender 102 may or may not detect the hacked HTTPD. In some instances, the Defender 102 may remove the compromised account and may restart the HTTPD.

In another exemplary operation, the attacker 104 may compromise or hack the HTTPD as described above but the HTTPD may not be recovered. The attacker 104 may deface a Website in the Webserver 124. The defender 102 may detect the defaced Website and may restore the Website and may remove the compromised HTTPD account.

In another exemplary operation, the attacker 104 may compromise or hack the HTTPD as described above but the HTTPD may not be recovered. The attacker 104 may install a sniffer and/or a backdoor program. The sniffer may comprise computer software or hardware that can intercept and/or log traffic passing into or though the enterprise network 110. The backdoor program may comprise malicious software and may be operable to bypass normal authentication to secure illegal or unauthorized remote access to the enterprise network 110 and/or one or more entities in the enterprise network 110. The backdoor program may gain access to information in the network while attempting to remain undetected. The backdoor program may appear as an installed program or may comprise rootkit, for example. The rootkit may comprise stealthy software that may attempt to hide the existence of processes and/or programs from detection and may enable continued privileged access to one or more of the various entities in the enterprise network 110. Furthermore, the attacker may run a denial of service (DOS) virus on the Webserver 124. The denial-of-service virus or a distributed denial-of-service virus may comprise computer software that may attempt to make one or more of the network resources unavailable to intended or authorized users. The denial of service virus may interrupt or suspend services of the one or more entities in the enterprise network 110. The enterprise network 110 traffic load may increase and may degrade system operation. The defender 102 may detect the altered traffic volume and may identify the denial of service virus. The defender 102 may remove the denial of service virus and may remove the compromised HTTPD account.

In another exemplary operation, the attacker 104 may compromise or hack the HTTPD as described above but the HTTPD may not be recovered. The attacker 104 may install a sniffer and/or a backdoor program. The attacker 104 may attempt to crack the root password of the fileserver 128. The attacker 104 may determine the root password and gain access to the fileserver 128 or may disable, manipulate or bypass the system security mechanisms and gain access to the fileserver 128. In other words, the attacker 104 may crack the password and the fileserver 128 may be hacked. The attacker 104 may download data from the fileserver 128. The defender 102 may detect the fileserver hack and may remove server from the enterprise network 110.

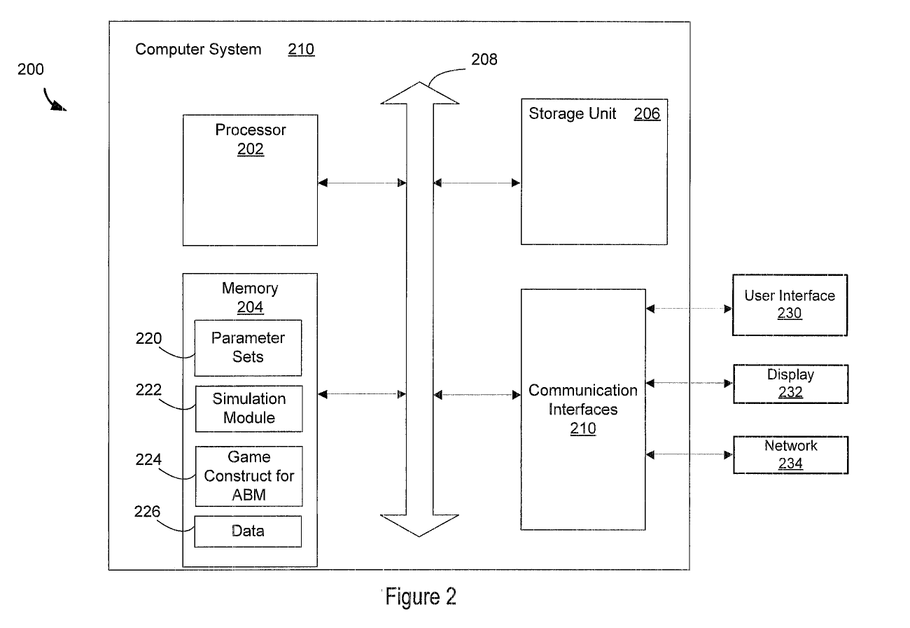

Information analysis of each of the exemplary operations above may be performed in a computer system 210 (shown in FIG. 2) based on a game constructed or implemented within dynamic simulations of an agent based model (ABM) in the computer system 210. In the ABM simulations performed by the computer system 210, the attacker 104 and/or the defender 102 may be configured as active components of the agent based model, which may engage in interactions in a plurality of simulated scenarios. The active components configured in the ABM simulations may be referred to as the attacker 104 and/or the defender 102. The attacker 104 and defender 102 as configured in the ABM simulations may be referred to as agents, participants, players, opponents or adversaries, for example. Furthermore, the agent based model simulations may be configured to simulate evolutionary game theory involving multiple players in both cooperative and competitive or adversarial postures.

FIG. 2 illustrates an exemplary computer system that may be utilized to analyze security in an information system by modeling the information system as a game construct in an agent based model simulation. Referring to FIG. 2, a system 200 comprises a computer system 210, one or more processors 202, one or more memory devices 204, one or more storage devices 206, one or more communication buses 208 and one or more communication interfaces 210.

The computer system 210 may comprise any suitable logic, circuitry, interfaces or code that may be operable to perform the methods described herein. The computer system 210 may include the one or more processors 202, for example, a central processing unit (CPU), a graphics processing unit (GPU), or both. The one or more processors 202 may be implemented utilizing any of a controller, a microprocessor, a digital signal processor, a microcontroller, an application specific integrated circuit (ASIC), a discrete logic, or other types of circuits or logic. The one or more processors 202 may be operable to communicate via the bus 208. The one or more processors 202 may be operable to execute a plurality of instructions to perform the methods describe herein including simulations of a game construct in an agent based model.

The computer system 210 may include the one or more memory devices 204 that may communicate via the bus 208. The one or more memory devices 204 may comprise a main memory, a static memory, or a dynamic memory, for example. The memory 204 may include, but may not be limited to internal and/or external computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In some systems, the memory 204 may include a cache or random access memory for the processor 202. Alternatively or in addition, the memory 204 may be separate from the processor 202, such as a cache memory of a processor, the system memory, or other memory.

The computer system 210 may also include a disk drive unit 206, and one or more communication interface devices 214. The one or more interface devices 214 may include any suitable type of interface for wireless, wire line or optical communication between the computer system 210 and another device or network. For example, the computer system 210 may be communicatively coupled to a network 234 via the one or more interface devices 214 which may comprise an Ethernet and/or USB connection. The computer system 210 may be operable to transmit or receive information, for example, configuration data, collected data or any other suitable information that may be utilized to perform the methods described herein.

The computer system 210 may further include a display unit 232, for example, a liquid crystal display (LCD), an organic light emitting diode (OLED), a flat panel display, a solid state display, or a cathode ray tube (CRT). Additionally, the computer system 210 may include an input device 230, such as a keyboard and/or a cursor control device such as a mouse or any other suitable input device.

The disk drive unit 206 may include a computer-readable medium in which one or more sets of instructions, for example, software, may be embedded. Further, the instructions may embody one or more of the methods and/or logic as described herein for executing ABM simulations of real or realistic information system activity utilizing game constructs and game theory decision making. In some systems, the instructions may reside completely, or at least partially, within the main memory or static memory 204, and/or within the processor 202 during execution by the computer system 210. The memory 204 and/or the processor 202 also may include computer-readable media.

In general, the logic and processing of the methods described herein may be encoded and/or stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium as, for examples, instructions for execution by a processor, controller, or other processing device. The medium may be implemented as any device or tangible component that contains, stores, communicates, propagates, or transports executable instructions for use by or in connection with an instruction executable system, apparatus, or device. Alternatively or additionally, the logic may be implemented as analog or digital logic using hardware, such as one or more integrated circuits, or one or more processors executing instructions that perform the processing described above, or in software in an application programming interface (API) or in a Dynamic Link Library (DLL), functions available in a shared memory or defined as local or remote procedure calls, or as a combination of hardware and software.

The system may include additional or different logic and may be implemented in many different ways. Memories may be Dynamic Random Access Memory (DRAM), Static Random Access Memory (SRAM), Flash, or other types of memory, for example. Parameters and other data structures may be separately stored and managed, may be incorporated into a single memory or database, or may be logically and physically organized in many different ways. Programs and instructions may be parts of a single program, separate programs, implemented in libraries such as Dynamic Link Libraries (DLLs), or distributed across several memories, processors, cards, and systems.

The computer system 210 may comprise the simulation module 222 which may comprise any suitable logic, circuitry, interfaces and/or code that may be operable to simulate the methods described herein. For example, the simulation module 222 may be configured as a game construct representing aspects of a real information system and may simulate behavior of real participants as probabilistic decisions with probabilistic results of actions. The participants may be modeled as competitors in a game. The simulations may provide a measure of the probability of various aspects of security and/or vulnerability in the information system. For example, probabilities related to system or information integrity, confidentiality and availability may be determined from the outcome of the simulations. In another example, the probability that an attack is successful may be measured by output from the simulation module 222.

Once the simulation module 222 is configured for a specified game construct, for example, configured with the agent based model 224, the simulator 222 may process a sequence of events in accordance with the configuration parameters 220. The simulation module 222 may output data 226 indicating the results of the simulated events. For example, data 226 may comprise information indicating which actions were executed, results of player actions, payoff scores, game state information, attack arrival rates, game results and/or statistics. The data 226 may comprise a step by step log or trace file comprising raw data that may be used for future step by step analysis, for example. Alternatively or in addition, the collected data 226 may comprise statistical analysis of simulated events or decisions which may be updated for each step or at designated states or events. Some states in the simulation may be tagged or targeted and the data 226 may be determined or collected when one or more of the target states are reached. For example, data or statistics may be determined that indicates the probability of a specified target state being encountered over time, how often the target state is arrived at or various simulator configurations or conditions which may be in effect when the target state occurred. The simulation module 222 may be referred to as a simulator, an application or an engine, for example.

The simulation module 222 may be a discrete event simulator and may be defined and/or implemented by any suitable type of code, for example Java language. In some systems, a generic or off the shelf simulator may be utilized, such as, an ADEVS or NetLogo simulator, however, the system is not limited in this regard and any suitable computerized or automated method of simulation may be utilized. Some generic or off the shelf simulators may require modification in order to enable configuration and/or simulation of the game constructs and agent based models described herein. In some systems the configuration information for the game construct in the simulator 222 may be specified or defined in a file and loaded into the simulator 222. For example, a configuration specification may be coded in a document markup language, such as Extensible Markup Language (XML), and loaded into the simulator 222 prior to executing the game model. However, the system is not limited in this regard and any suitable method may be utilized for provisioning the simulator 222 to construct a game for predicting aspects of security in a real information system.

An example of information that may be configured in the simulator 222 to construct a game model for analysis of a real information system such as the Enterprise 110 may include state objects, player objects, allowed actions, data objects, rules of engagement and simulation controls. For example, the rules may indicate in which state or states a certain action may be executed. Moreover, the rules may identify probabilities associated with a player's decision to take an action or that an action will be taken, probabilities associated with whether an action is successful, the consequences or payoff related to a specified action in a simulation step or related to a specified state, and which state or states the simulation may advance to from a specified state, for example.

Furthermore, a game construct configured in the simulator 222 may specify controls and parameters for implementing the simulations. For example, the controls and parameters may determine how long a sequence of simulations may run, or how many times a game may be played as a sequence of simulations. The controls may determine when a player may begin taking action and when data may be collected. Furthermore, a unit of time or time increment, for example, a fraction of a second, a minute, an hour or days may be modeled to represent time intervals in a real information system such as the enterprise system 110. In this regard, events in a simulation that may be executed in a fraction of a second may be assigned a number of time units that correspond to an interval of time needed to perform an action or wait in delay of operation in the real information system 110.

While various systems have been described, it will be apparent to those of ordinary skill in the art that many more systems and implementations are possible to enable the methods described herein. In some systems, the computer system 210 may be integrated within a single computing and/or communication device, however the system is not limited in this regard. For example, one or more of the elements of the computer system 210 may be distributed among a plurality of devices which may communicate via a network.

In operation, the computer system 210 may execute a series of commands representing the method steps described herein. The computer system 210 may be a mainframe, a super computer, a distributed system, a PC or Apple Mac personal computer, a hand-held device, a tablet, a smart phone, or a central processing unit known in the art, for example. The computer system 210 may be preprogrammed with a series of instructions that, when executed, may cause the computer to perform the method steps as described and claimed in this application. The instructions that are performed may be stored on a non-transitory machine-readable data storage device. The non-transitory machine-readable data storage device may be a portable memory device that is readable by the computer apparatus. Such portable memory device may be a compact disk (CD), digital video disk (DVD), a Flash Drive, any other disk readable by a disk driver embedded or externally connected to a computer, a memory stick, or any other portable storage medium currently available or yet to be invented. Alternately, the machine readable data storage device may be an embedded component of a computer such as a hard disk or a flash drive of a computer. The computer and machine-readable data storage device may be a standalone device or a device that may be imbedded into a machine or system that may use the instructions for a useful result. The instructions may be data stored in a non-transitory computer-readable memory or storage media in a format that allows for further processing, for example, suitable file, array, or data structure. Provided herein is an agent based model for simulating an attack on a system. The computer system 210 may be preprogrammed with a series of instructions that, when executed, may cause the one or more processors 202 to perform the method steps of: providing an attacker agent having a number of actions in a system with each action having a probability of attempting the action value, a probability of success of the action value, a payoff value, an initial state value and a final state value; providing a defender agent having a number of actions in a system with each action having a probability of attempting the action value, a probability of success of the action value, a payoff value, an initial state value and a final state value; and, performing an action by each of the attacker and defender to change a system state of the system.

Furthermore in operation, the agent based model simulations performed in the computer system 210 may be configured for one or more information assets that may represent the enterprise network 110 and/or one or more of the entities included in the enterprise network 110 such as the Webserver 124, for example. The information assets as configured for the ABM simulation may be referred to as the enterprise network 110 or the Webserver 124, for example. The attacker 104 and/or defender 102 as configured participants in the ABM simulation may perform actions that may change the state of the information asset. For each state of an information asset or system in the ABM simulation, each of the participants may be limited with respect to which actions are allowed. Depending on the parameters of a particular simulated scenario, the attacker 104 may decide to execute an action or may decide not to execute an action based on a probability. In instances when the attacker decides to take an action and the action is executed, the action may or may not be successful based on another probability. Within each unit of time or step in the ABM simulation, a simulator thread may visit both of the agents, for example, the attacker 104 and the defender 102, may be given an opportunity to perform an action or not to perform the action based on a probability associated with deciding to take the action. In instances when there is contention, for example, when both participants take an action that would result in a different next state occurring, the simulator may arbitrate and determine which participant prevails and may drop the actions taken by the other participant during that simulation step. For example, the simulator may determine which participant prevails by randomly selecting one of the participants, giving each a 50 percent chance of prevailing, however, the system is not limited in this regard and any suitable method of contention arbitration or avoiding contentious state transitions may be utilized.

The defender 102 as an active component configured in the ABM simulations may represent a human system administrator or a non-human entity such as a security software process that may be operable to detect an attack and may execute an action to mitigate an impairment caused by the attack. For example, the defender 102 may perform actions based on probabilities that are preceded by detecting something is wrong with an asset in the enterprise 110 based on another probability. A current state of the asset or system may be known at each step and the configured ABM simulation 222 may limit which of the actions the defender 102 and/or the attacker 104 is allowed to take. For example, the defender 102 may be limited to take a counter action to the most recent action performed by the attacker 104. This assumption may be based on the notion that a competent system administrator or defender is able to recognize a problem within an information system for which they are responsible. In some instances, prior to the defender 102 performing a counter action or corrective action, the defender 102 may detect an attack or state to determine which type of attack has occurred.

Agent based model simulations may be configured to run a plurality of simulation scenarios or a sequence of scenarios, where each scenario may comprise of a number of steps. In an exemplary game model ABM simulation, a unit of time or increment for each simulation step may represent one minute and a thousand simulations may be executed with each simulation spanning a maximum of 250 simulated minutes. Data output from the thousand simulations may be averaged to provide results representative of reality or nature. However, the system is not limited with respect to any specific units of time, maximum steps per simulation or specific number of executed simulations and any suitable values may be utilized. Results from the plurality ABM simulated scenarios, for example, from a sufficient number of runs (e.g. 1000 runs of simulation), may be aggregated into bins and averaged to determine the probabilities of successful attacks in the enterprise network 110.

Table 1 represents one exemplary scenario for game oriented ABM simulation in which the modeled HTTPD Webserver 124 is hacked by the attacker 104 and is successfully recovered by the defender 102. The game oriented ABM simulation scenarios may provide information about the agent interactions and the probabilities associated with decision points in the scenarios. As the game oriented ABM simulation may represent a real information system, the probabilities utilized as parameters in the game oriented ABM simulation scenarios may be based on research, studies or surveys of people, systems and events in an information system. The scenario information may be configured in the game oriented agent based model simulation computer system 210. In some scenarios, there may be a plurality of branches where the attacker 104 can make a decision as to which action to take.

TABLE 1
Simulation Scenario 001 Hacked HTTPD Webserver-(Showing
Simulation Parameters)

| Simulation Scenario 001—Steps where | |
|---|---|
| HTTPD Webserver is hacked | |
| and recovered | Simulation parameters and notes |
| 1. The attacker attacks an httpd process | attack_httpd, P(a) = 0.5, P(s) = 1.0 |
| 2. The attacker continues the attack to | continue_attacking, P(a) = 0.5, |
| compromise the httpd | P(s) = 0.5 |
| 3. The attacker compromises the httpd | State change to httpd_hacked |
| system, httpd has been hacked | |
| 4. The admin detects the hacked httpd | detect_httpd_hacked, P(a) = 0.5, |
| | P(s) = 0.5, payoff = −1 |
| 5. The admin removes the compromised | remove_compromised_account_ |
| account and restarts httpd | restart_httpd, P(a) = 1.0, P(s) = 1.0, |
| | payoff = −20 |

The system or asset configured for the ABM simulation scenario shown in Table 1 may comprise the HTTPD Webserver 124. In Table 1, P(a) may represent a probability of whether an agent will take an action, and in instances when the action is taken, P(s) may represent the probability that the action taken will be successful. In some instances, the system in the ABM simulation may be configured to begin in a stable state. For example, the ABM modeled HTTPD Webserver 124 may begin an 001 scenario in a state of operation without impairment or a state that does not require corrective action by the defender 104. In instances when a simulated action is successful in a particular scenario, a change of state may be triggered in the ABM simulation. For example, at each unit of time that the attacker 104 has an opportunity to take the action indicated as continue_attacking (see step 2 of Table 1), there is a 0.5 uniform probability that the attacker 104 will perform the continue_attacking action, and in instances when the attacker 104 performs that action, there is 0.5 probability that the attacker 104 will succeed in compromising the HTTPD Webserver 124 system. In instances when the attacker 104 succeeds in compromising the system, the state of the system may change from the stable state to the httpd_hacked state (see step 3 of Table 1). In instances when the defender 102 detects the httpd_hacked state (see step 4 of Table 1), a payoff of −1 may result which may indicate a score received for detecting the attacked state. In some systems the payoff of −1 may also indicate that 1 unit of time is needed to perform the detection, and recovery of the HTTPD Webserver 124 system may not be considered until the next time unit. In this regard, a payoff of a negative value may be interpreted as score for an action, or as just stated, as a delay in the number of time units utilized for a particular step in the simulated scenario. At the next time frame, in step 5 of Table 1, in instances when the defender 102 detected the httpd_hacked state in step 4, the defender 102 may perform the remove_compromised_account_restart_httpd action, which has a probability of 1.0 for taking the action and a probability of 1.0 that the action will be successful. A successful remove_compromised_account_restart_httpd action may have a payoff of −20 which may indicate that a duration of 20 time units may be utilized to perform the remove_compromised_account_restart_httpd action and a score of −20 may be received for the simulation step. In this regard, the results of the action, such as a change of state, may take effect in the time increment following the 20 time unit delay.

Tables 2, 3 and 4 comprise examples of additional simulation scenarios 002, 003 and 004 that may be configured and executed in the computer system 210 (shown in FIG. 2). The steps shown in the scenarios of Tables 2, 3 and 4 may also have associated simulation parameters such as P(a), P(s) and payoff as described with respect to the scenario shown in Table 1, however, the associated simulation parameters are not shown in the Tables 2, 3 and 4.

TABLE 2
Simulation Scenario 002—Defacing a Website with Correction by the
Defender (Simulation Parameters Not Shown)
Scenario 002—Defacing a Website of a hacked HTTPD Webserver

1. The httpd is hacked, but not recovered (See step 3 of Table 1,
state = httpd_hacked)
2. The attacker defaces a Website
3. The defender detects the defaced Website
4. The defender restores the website and removes the compromised account

The scenario 002 shown in Table 2 begins with the Webserver 124 as having been compromised by the attacker 104 and in the httpd_hacked state. The simulated scenario 002 may or may not advance through one or more steps shown in Table 2 in accordance with configured payoff time unit values, based on various probabilities for each of (1) executing the actions shown in Table 2, (2) detecting the actions or detecting states caused by the actions in instances when actions were executed, and (3) the actions being successful in instances when the actions were executed. In this manner, from the httpd_hacked state, the attacker 104 may or may not deface a Website in the Webserver 124. The defender 102 may or may not detect the defaced Website and the defender may or may not restore the Website and remove the compromised account in instances that the Website and the account were compromised.

TABLE 3
Simulation Scenario 003—Denial of Service (DOS)-(Simulation
Parameters Not Shown)
Scenario 003-Denial of Service (DOS)

1. The httpd is hacked, but not recovered (See step 3 of Table 1,
state = httpd_hacked)
2. The attacker installs a sniffer and backdoor program
3. The attacker runs a DOS virus on the Webserver
4. The enterprise network traffic load increases and degrades the
system performance
5. The defender detects the traffic volume and identifies the DOS virus
6. The defender removes the DOS virus and the compromised account

The scenario 003 shown in Table 3 begins with a representation of the Webserver 124 as having been compromised by the attacker 104 and in the httpd_hacked state. The simulated scenario 003 may or may not advance through one or more steps shown in Table 3 in accordance with configured payoff time unit values, based on various probabilities for each of (1) executing the actions shown in Table 3, (2) detecting the actions or detecting states caused by the actions in instances when actions were executed, and (3) the actions being successful in instances when the actions were executed. In this manner, from the httpd_hacked state, the attacker 104 may or may not install a sniffer and backdoor program in the Webserver 124. The attacker 104 may or may not run a DOS virus on the Webserver 124. The enterprise network traffic load may or may not and degrade system performance depending on if the attacker 104 was successful. The defender 102 may or may not detect the traffic volume increase and identify the DOS virus in instances when the traffic load increased. The defender may or may not remove the DOS virus and may remove the compromised account in instances when the defender 102 detected the volume increase and the account was compromised.

TABLE 4
Simulation Scenario 004—File Server Data Stolen-(Simulation
Parameters Not Shown)
Scenario 004—File Server Data Stolen

1. The httpd is hacked, but not recovered (See step 3 of Table 1,
state = httpd_hacked)
2. The attacker installs a sniffer and backdoor program
3. The attacker attempts to crack the fileserver root password
4. The attacker cracks the root password; the fileserver is in a hacked state
5. The attacker downloads data from the file server
6. The defender detects the file server hacked state
7. The defender removes the fileserver from the network

The scenario 004 shown in Table 4 begins with a representation of the Webserver 124 as having been compromised by the attacker 104 and in the httpd_hacked state. The simulated scenario 004 may or may not advance through one or more steps shown in Table 4 in accordance with payoff time unit values and based on various probabilities configured in the ABM simulation (not shown) for each of the actions and/or states depicted in Table 4.

The following exemplary state objects may be configured in the ABM simulation to indicate states that may be embodied or reached in a simulation step of the scenarios described above with respect to Tables 1-4 and/or in other scenarios that may be defined and/or configured in ABM simulations. For example, the following exemplary state objects may represent states that may occur in the enterprise 110 or one or more of the resources of the enterprise 110 that may be configured as assets in the ABM simulation. However, the system is not limited with regard to any specific states and any suitable states or suitable combination of state content may be utilized.

1. normal_operation

2. httpd_attacked

3. httpd_hacked
a. detect. httpd_hacked_detected

4. ftpd_attacked

5. ftpd_hacked

6. website_defaced
a. detect. website_defaced_detected

7. webserver_sniffer

8. webserver_sniffer_detector

9. webserver_dos_{—}1
a. detect. webserver_dos_{—}1_detected

10. webserver_dos_{—}2

11. fileserver_hacked
a. detect. fileserver_hacked_detected

12. fileserver_data_stolen_{—}1

13. workstation hacked
a. detect. workstation_hacked_detected

14. workstation_data_stolen_{—}1

15. network_shut_down

Each state of an ABM scenario simulation may be associated with one or more action candidates. For example, while an information asset or system such as one or more of the entities in the enterprise network 110, is in a particular state, a player or agent such as the attacker 104 or the defender 102 may be operable to execute an action selected from one or more candidate actions that may be associated with the particular state. When a player takes no action, it may be referred to as inaction and may be denoted as ø. For example, while a system is in a stable, secure or normal operation state, a specified attacker may be allowed to execute one or more of an attack_httpd action, an attack_ftpd action or ø. An attacker may be configured as all actions which the attacker is allowed to execute in all configured allowable states. Examples of allowed actions that may be executed by the attacker 104 may include:

Attack_httpd

Attack_ftpd

Continue_attacking

Deface_website_leave

Install_sniffer

Run_DOS_virus

Crack_file_server_root_password

Crack_workstation_root_password

Capture_data

Shutdown_Network

Examples of allowed actions by the defender 102 may include:

Remove_compromised_account_restart_httpd

Restore_Website_remove_compromised_account

Remove_virus_and_compromised_account

Install_sniffer_detector

Remove_sniffer_detector

Remove_compromised_account_restart_ftpd

Remove_compromised_account_sniffer

In real world situations, a network administrator often faces a dynamic competition against an attacker and may have incomplete and imperfect information prior to actions being detected or understood by the administrator. The ABM simulation described herein may be configured with similar features, such that the defender 104 may or may not know or detect whether an attacker present, for example. Furthermore, the attacker 104 may utilize multiple objectives and strategies that the defender may or may not detect. Another realistic aspect of this model is that probabilities may be assigned to an attack and/or to success of the attack. Furthermore, the defender may not observe or respond to all of the actions taken by the attacker 104.

Tables 5 and 6 specify parameters and logic that may be utilized during simulation of an agent based computational model that represents an information asset, for example, the enterprise network 110 and/or one or more entities in the enterprise network 110 described with respect to FIG. 1. Tables 5 and 6 may provide a framework to guide the simulation process and advancement from one state to another based on probabilities of an action, probabilities of success in instances when an action is executed and payoffs which may indicate a time delay or an number of time increments utilized to take the action.

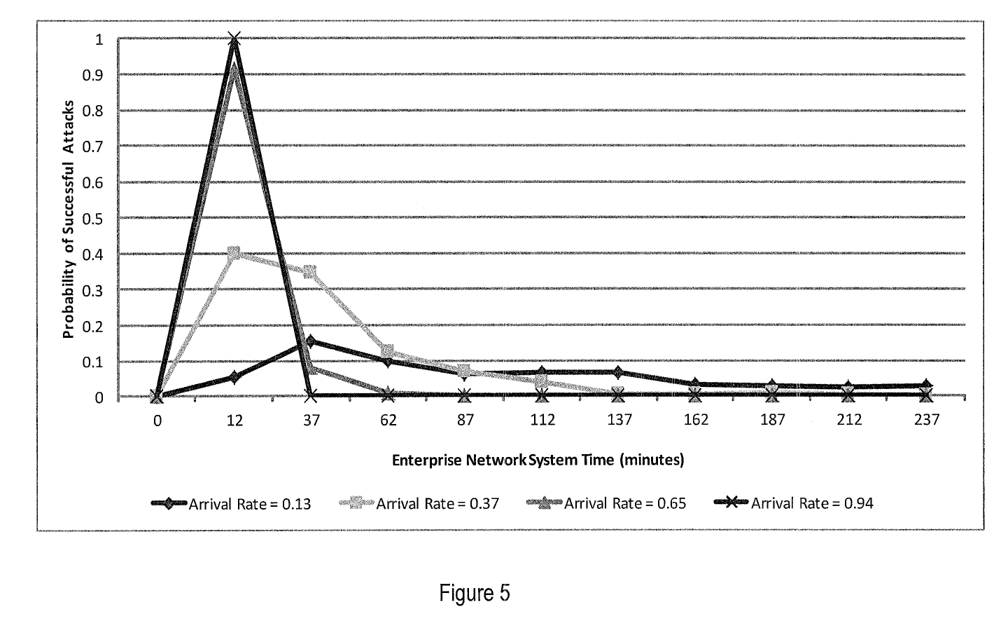

Table 5 provides an example of rules of engagement for the simulated attacker 104 when the simulated attacker is engaged in competition with the simulated defender 102. For each step of a simulation, Table 5 defines a number of actions that may be taken by the attacker 104, depending on the current state of the simulation. In other words, from a particular state in a simulation, the attacker 104 may be allowed to take only those actions which are specified for that state, based on probabilities. Each action in Table 5 may be associated with a probability that the action will be executed from a specified state, and a probability that the action will be successful in instances when the action is executed. Table 5 also indicates to which state the game or simulation will advance in instances when the action is successful. In some systems, it may be assumed that the initial state of a simulation or game is a state of normal or stable operation. Also, each action in Table 5 is associated with a payoff which may indicate the number of time units incremented in the simulation for the execution of the action. The simulated time units may be configured to represent any suitable time of a real process, for example a millisecond, a second, a minute or a day. The parameter modeling set shown in Table 5 was utilized to guide data collection and analysis for the attacker 104 for the ABM simulation results shown in FIGS. 5-9.

TABLE 5
Attacker Modeling Parameter Set

| | Probability | Probability | | State | State |
|---|---|---|---|---|---|
| Action Name | of Action | of Success | Payoff | From | To |
| attack_httpd | 0.5 | 0.5 | 10 | 1 | 2 |
| continue_attacking | 0.5 | 0.5 | 0 | 2 | 3 |
| deface_website_leave | 0.5 | 0.5 | 99 | 3 | 6 |
| install_sniffer | 0.5 | 0.5 | 10 | 3 | 7 |
| run_dos_virus | 0.5 | 0.5 | 30 | 7 | 9 |
| crack_file_server_ | 0.5 | 0.5 | 50 | 7 | 11 |
| root_password | | | | | |
| capture_data_file_server | 0.5 | 0.5 | 999 | 11 | 12 |
| shutdown_network | 0.5 | 0.5 | 999 | 9 | 15 |

Table 6 provides an example of rules of engagement for the simulated defender 102 when the simulated defender is engaged in competition with the simulated attacker 104. For each step of a simulation, Table 6 defines a number of actions that may be taken by the defender 102, depending on the current state of the simulation. In other words, from a particular state in a simulation, the defender 102 may be allowed to take only those actions which are specified for that state, based on probabilities. Each action in Table 6 may be associated with a probability that the action will be executed from a specified state, and a probability that the action will be successful in instances when the action is executed. Table 6 also indicates to which state the game or simulation will advance in instances when the action is successful. Also, each action in Table 6 is associated with a payoff which may indicate the number of time units incremented in the simulation for the execution of the action. The parameter modeling set shown in Table 6 was utilized to guide data collection and analysis for the defender 102 for the ABM simulation results shown in FIGS. 5-9.

TABLE 6
Defender Modeling Parameter Set

| | Probability | Probability | | State | State |
|---|---|---|---|---|---|
| Action Name | of Action | of Success | Payoff | From | To |
| detect_httpd_hacked | 0.5 | 0.5 | −1 | 3 | 3a |
| detect_defaced_website | 0.5 | 0.5 | −1 | 6 | 6a |
| detect_webserver_sniffer | 0.5 | 0.5 | −1 | 7 | 8 |
| remove_sniffer | 1.0 | 1.0 | 0 | 8 | 1 |
| remove_compromised_ | 1.0 | 1.0 | −10 | 3a | 1 |
| account_restart_httpd | | | | | |
| restore_website_remove_ | 1.0 | 1.0 | −10 | 6a | 1 |
| compromised_account | | | | | |
| detect_dos_virus | 0.5 | 0.5 | −1 | 9 | 9a |
| remove_virus_and_ | 1.0 | 1.0 | −3 | 9a | 1 |
| compromised_account | | | | | |
| detect_fileserver_hacked | 0.5 | 1.0 | −1 | 11 | 11a |
| remove_compromised_ | 1.0 | 1.0 | −20 | 11a | 1 |
| account_restore_fileserver | | | | | |

The enterprise system 110 may begin in a normal or healthy state of operation and may return to the normal or healthy state after the defender 102 recovers the system from a successful attack. In this normal or healthy state, the enterprise system 110 may be referred to as being in a secure state. The secure or normal state may be referred to as state 1 in Tables 5 and 6. The defender's actions may comprise counter actions relative to the most current action performed by the attacker 104. Once the attacker 104 performs an action, the defender 102 may perform a detection action prior to taking a counter action. The simulator may run as a state machine where at each step of the simulation, both the attacker 104 and the defender 102 may be given a chance to take a turn and a new state may be determined. Each of the states may be designated as a beginning state or an end state, and may be designated as a target state, where some states may be designated as both a target state and an end state. A simulation may begin in a beginning or start state. At each step or at designated steps or states, the simulator 222 may log data about activity or statistics corresponding to the present step or state and/or other steps or states. In this regard, raw data regarding the events or actions taken or detected during each time unit in a simulation may be logged. This raw data may be collected and analyzed at a later time. Furthermore, statistics may be calculated at each time unit or step of a simulation or at designated target states, for example. The statistics may indicate aspects of security or probabilities of events occurring for a particular game state over time, for example.

Each simulation or scenario may be allowed a maximum number of simulation steps and the simulator 222 may be configured for a specified number of simulation scenarios. In one example, each run of the simulator 222 may be allowed 250 steps and the simulator may perform 1000 simulation runs. A simulation may run until a state designated as an end state is reached or until the maximum allowed number of simulation steps has occurred, for example. In some systems, the end states may be designed into the state machine and there may be more than one state designated as an end state. There may be zero or any suitable number of end states for the attacker 104 and zero or any suitable number of end states for the defender 102. In instances when a simulation max time or max steps expires, and an end state has not been reached, the simulation may not have executed long enough and may be run again for a longer duration. Alternatively, the simulation may be executing in a loop among one or more states and any significance of the loop may be taken into consideration in analysis of the data or configuration of the simulator 222. Also, in instances when a simulation expires and there is not an apparent end state, points accumulated for the attacker 104 and the defender 102 as payoff scores during the simulation may be utilized as a measure of game results, for example, success by the attacker and/or damage incurred by the defender. The scoring may be utilized to assess risk in the enterprise system 110.

With regard to Tables 5 and 6, game theory analysis and simulation may be based on two kinds of outcomes: points acquired based on a non-zero sum game and arrival at a designated end state. For the attacker 104, payoff points may be summed to indicate a score or an amount of gain or advantage the attacker has over the system, despite the defender and despite an outcome of arriving at an end state. For the defender 102, the payoff points may indicate the amount of gain or loss incurred over time during the simulation. The negative values may also be assigned as an additional amount of time the defender has to stay in the respective state 102. In instances when an end sate is not achieved, any negative point value may indicate a measure of the loss of points. The total number of payoff points which may be acquired by both of the participants is not fixed and depends on the players' moves due to the probabilities designed or configured in a state machine utilized in running the simulations.

A simulation may be executed on a turn-based approach. Time may progress in steps of equal sized time increments. Each player, attacker 104 and/or defender 102, is not required to take a turn in each. When a participant takes a turn, the allowed actions or decisions may depend on the system state. Both players may take actions without knowledge of how the other player may act. In some systems, there may be conditional probabilities, where one player may make a decision based on a prior move of the other.

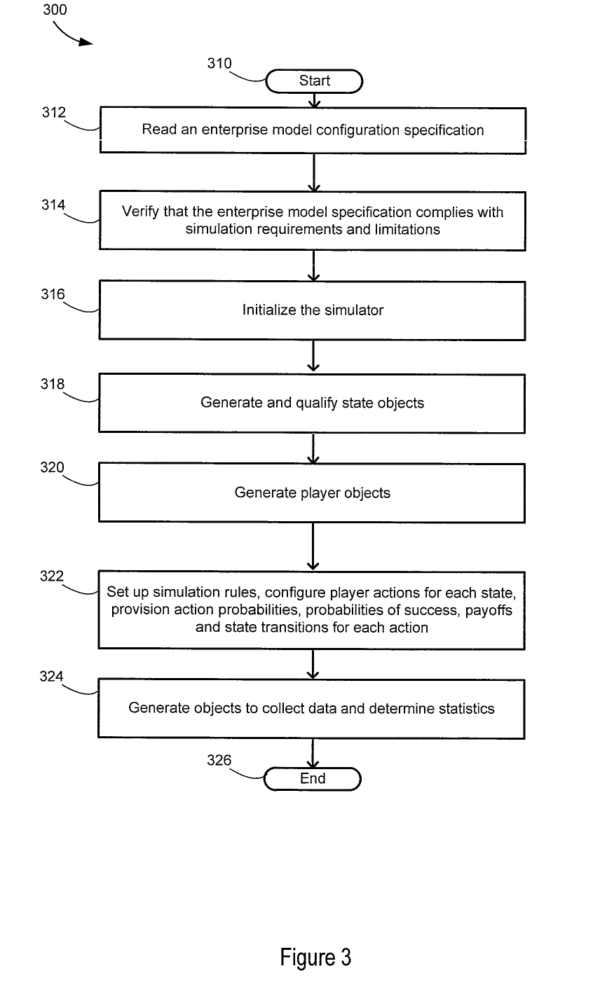

FIG. 3 is a flow chart comprising exemplary steps for configuring a simulator to virtualize an information system as a game construct utilizing an agent based model. The simulator 222 may be configured to virtualize the enterprise system 110 and enable simulation of the specified game.

The exemplary steps may begin in start step 310. In step 312, the computer system 210 may read a game model configuration into the simulator 222. In one example, the simulator 222 may read an XML file comprising a game model specification for analyzing security in the Enterprise network 110, however, the system is not limited in this regard. In step 314, the simulation application 222 of the computer system 210 may verify the values in the game model specification to determine compliance with simulator capabilities and data limitations. A consistency check may be performed to ensure that the information in the game model specification is complete and that when utilized, will instantiate a correct model. For example, the simulator 222 may check whether parameter values, such as probabilities, and thresholds are within specified limits. In step 316, the simulator 222 may be initialized. The simulator 222 application may be started and provided with the control parameters. For example, the control parameters may specify the maximum number of steps in each run of the simulator, the number of simulations to run and/or the name and/or location of one or more output files for reporting simulation events and results, simulation logs or simulation statistics. The control parameters may indicate which data to collect. Furthermore the control parameters may be used to initialize a seed value for one or more random generators used by the simulator 222. In this regard, determining various events or outcomes that are based on the probabilities during simulation may rely on output from one or more random number generators. In step 318, the simulator 222 may generate state objects for use by the simulator 222. The state objects may be associated with one or more probability values that may be utilized to determine which of one or more states may be reached next. For example, state objects as described with respect to FIGS. 1 and 2 and Tables 1-6 may be generated or configured in the simulator 222. The state objects may be qualified by assigning an identification number (ID) to each state and/or designating states as a beginning state or an end state. Also each state may or may not be tagged as a target state for data collection or calculation of statistics, for example. In this regard, when a target state is reached data may be written to an output file or statistics may be calculated for the current state. For example, any suitable information may be written to a file such as statistics payoff scores, the time or simulation step when the designated state is reached. In step 320, the computer system 210 may generate player objects for the simulator 222 and may identify a type for each player. For example, the attacker 104 and the defender 102 may be created. In step 322, the simulator 222 may set up simulation rules as identified in the game model specification. Various probabilities, payoffs and state transitions may be provisioned in the simulator 222. For example, probabilities of attacker or defender action, detection or success may be configured. In step 324, objects may be created for collecting data and/or for determining statistics. The exemplary steps may end at step 326. Although the flow chart 300 described with respect to FIG. 3 comprises steps shown in a particular order, the steps in flow chart 300 may be performed in a different order. Furthermore, all or a portion of the content of the steps shown in FIG. 3 may be implemented by designing the content into a state machine or other application for simulating the game construct as an agent based model.

In operation, the simulator 222 may be configured with respect to the game participants and rules of engagement and competition. Allowed actions, action to state associations, probabilities of events and payoff assignments may be defined. In addition, various controls may be configured for the simulator 222 including how long or a maximum number of steps allowed to run each simulation, how many simulations to run, setting one or more random generator seeds, establishing an output data file, when to collect data, which data to collect and when to begin action, for example.

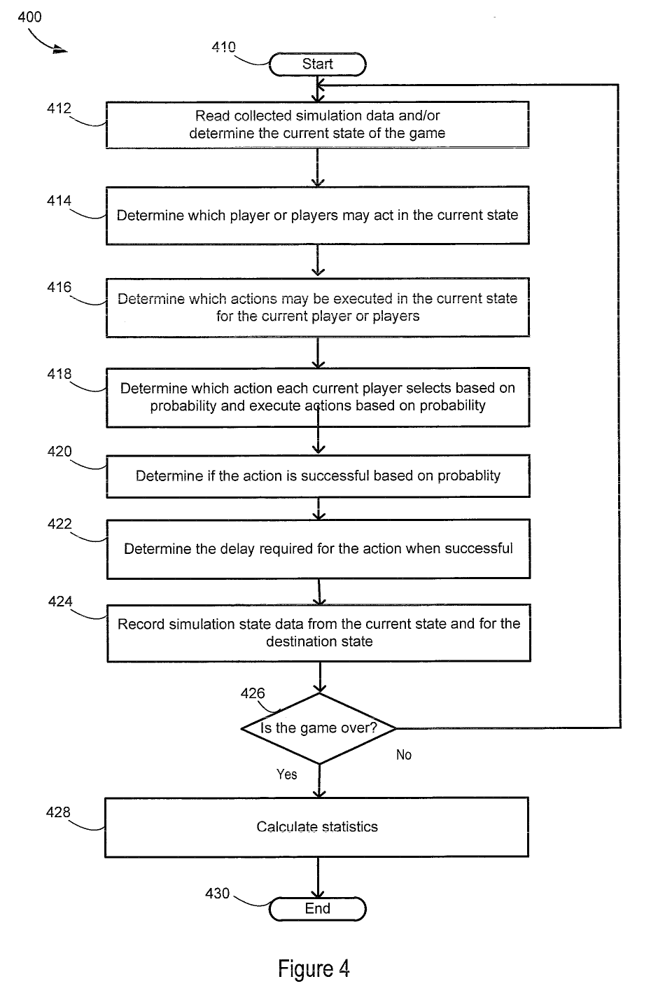

FIG. 4 is a flow chart comprising exemplary steps for executing a game model simulation representing active participants in an information system, to measure vulnerability probabilities of a real information system. The exemplary steps may begin at start step 410. In step 412, the configured simulator 222 may determine the current state of the game. The simulator 222 may read simulation data that may have been collected which may include data from a prior simulation step or state, to determine which state should be the current state of the game. In some instances, the simulator 222 may determine that the game is in a first or beginning state. In this regard, simulation data may not have been collected yet or the first or more steps in the game may not have advanced the game to a different state. In some systems, a beginning state may assume that the information system under consideration is operating properly or without significant impairments. The simulator 222 may determine the current state based on the state objects and rules configured in the simulator. For example, information from the state diagrams shown in Tables 5 and 6 may utilized to determine the current or destination state, where values in the “state to” column of a prior state may indicate which states are candidates for transitioning to the current or destination state.

In some instances, there may be contention with regard to which state should be the current state or in other words, the destination state “state to” of a given prior state or “state from.” For example, from some prior states, a successful player may be configured to advance to a choice from a plurality of available destination states. The simulator may determine which of the plurality of available destination states to advance to, based on probabilities assigned to each of the plurality of available destination states. In some systems, each of the destination states may be assigned a probability such that the sum of the probabilities may sum to 1 and the simulator may determine the destination state based on the assigned probabilities. Furthermore, in some prior states, there may be contention between the two players including the attacker 104 and the defender 102, for which state should be the destination state. For example, in a contentious situation, where both players turns are taken and each of the turns result in changing the game to a different state, such as state 6 and state 3, the destination state may be decided by giving the last player to take a turn, control of the destination state change, thereby overriding the first player's move. The simulator 222 may determine which player moved first by giving each player a 50 percent probability of being the first to move. The first mover may be the winner for the state transition. However, the system is not limited as to how contention in state transitions is resolved and any suitable method may be utilized to determine a current or destination state transition. In step 414, the simulator 222 may determine which player or players may take a turn in the current state. In some systems, for each time increment or step of the simulation, both of the players, attacker 104 and defender 102, may be allowed to take a turn and both may take a turn. However, in some instances, a player or both players may be blocked from taking a turn. In one example, the defender 102 may have actions which are allowable in state 6 but the attacker 104 may not have any assigned actions which are allowed in state 6 as shown in Tables 5 and 6. Therefore in state 6, the attacker 104 may not be able to take a turn. In another example, the defender 102 may be have received a negative payoff in a prior time increment and may be required to delay a specified number of time increments before advancing to a new state. In step 416, the simulator 222 may determine which actions may be executed in the current state for the current player or players. For example, Tables 5 and 6 indicate which action or actions may be taken by a given player in a given state. In step 418, the simulator 222 may determine which action each player taking a turn in the current state may select based on probability. For example, each of the attacker 104 and the defender 102 may have a choice of actions based on the allowed actions for the current state or “state from” in Tables 5 and 6. In instances when a multiple actions may be allowed for a player in a particular turn or current state, an action may be selected based on probabilities that may be assigned to each of the multiple allowed actions in the current state. For a selected action, a player may execute the action based on a probability assigned to the action as shown in Tables 5 and 6, in the “probability of action” columns. In step 420, for one or more actions which may be executed in step 418, success of each action may be determined based on probability, for example, the probabilities shown in Tables 5 and 6 for the attacker 104 and defender 102. In step 422, any delay which may result from successful actions in step 420, may be determined. In some systems a delay may be incurred for certain actions. For example, the negative payoff values shown in Table 7 may indicate a delay of action or a delay of state change for successful actions taken by the defender 102. In step 424, any simulation data may be logged for the current state. For example, decisions which were made during the current state based on probabilities may be logged. The simulator 222 may log the actions which were executed and which executed actions were successful. Furthermore, a score may be logged which may be determined based on assigned values, such as the payoff values defined in Tables 5 and 6. Moreover, the next state may be logged or information which may enable determination of the next state may be logged. In some systems, statistics for the current state may be generated in step 424. For example, instances when the current state is a target state, the simulator 222 may generate and record statistics for the current state. In step 426, in instances when the current state is not an end state or the number of steps allowed per simulation has not reached the maximum allowed steps, in accordance with the configuration of the simulator 222, the exemplary steps may proceed to step 412. In step 426, in instances when the current state is an end state or the maximum number of allowed states has been reached, the exemplary steps may proceed to step 428. In step 428, the simulator 222 may determine game statistics for the current game or for one or more of a plurality of games which may have been executed by the simulator 222 in accordance with the configuration of the simulator. For example, attacker arrival rates may be determined.

In operation, the simulator 222 may be configured to execute a plurality of game simulations. In this regard, the steps shown in the flow chart 400 of FIG. 4 may be repeated for each game simulation. For example, the simulator 222 may be configured to execute 1000 game simulations and statistics may be determined and/or averaged over all of the game simulations.

The flow chart 400 may implement a game construct in a simulation loop based on agent based models (ABM). The active components of the model may comprise the agents and may engage in interactions on scenario-by-scenario basis in a plurality of simulation loops. The agents in the simulations may include the attacker 104 and the defender 102 (or administrator). The agents perform actions that may change the system state of the virtual enterprise 110. For each state, the agents may be limited in the actions they may perform. Depending on the scenario or simulation run, the attacker 104 may execute one of many actions each with an associated probability of deciding to take the action and a probability that the action may be successful once the decision has been committed. Within each time unit, the simulator 222 thread may visit each agent giving them the opportunity to perform an action.

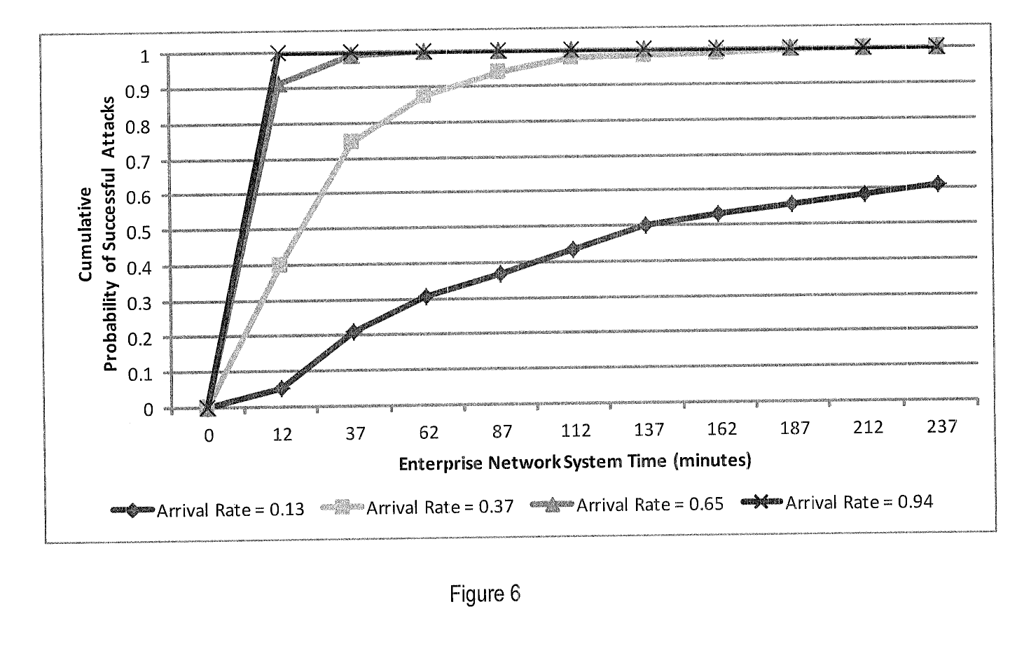

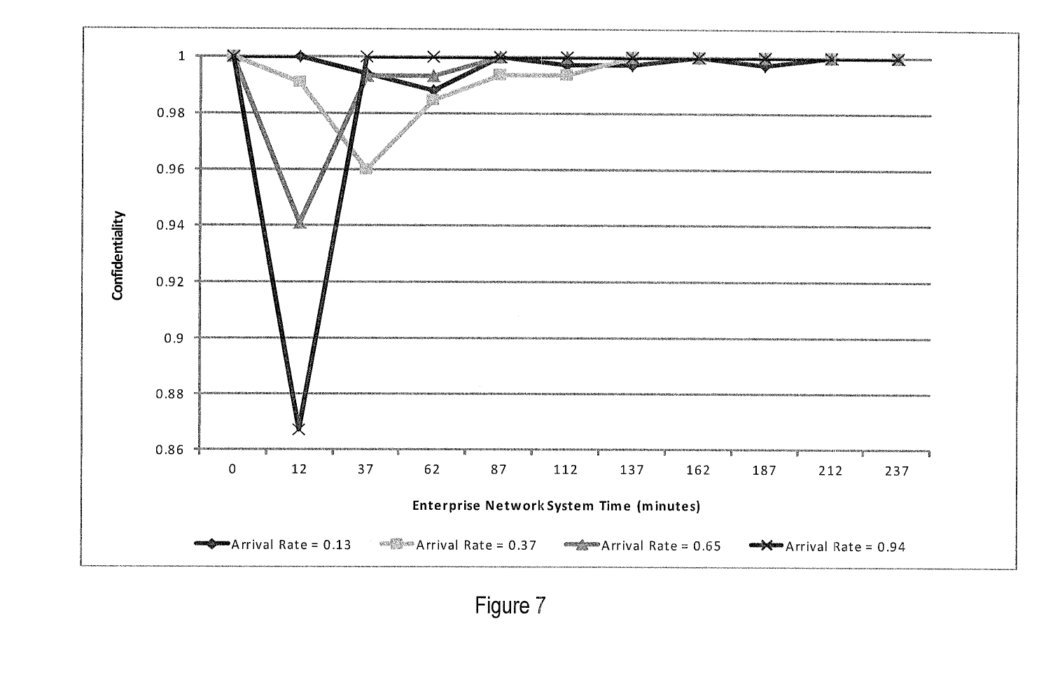

FIGS. 5-9 relate to results of simulating security of an enterprise network, based on the models described with respect to FIGS. 1-4. FIGS. 5 and 6 address what may constitute a successful attack in a system such as the enterprise network 110. FIGS. 7 through 9 address confidentiality, integrity and availability of a system such as the enterprise network 110. Information security may include a means of protecting information and/or information systems from unauthorized access, use, disclosure, disruption, modification, or destruction in order to provide confidentiality, integrity and/or availability. Confidentiality may comprise preserving authorized restrictions on access and disclosure, including means for protecting personal privacy and proprietary information. Integrity may comprise guarding against improper information modification or destruction, and may include ensuring information non-repudiation and authenticity. Availability may comprise ensuring timely and reliable access to and use of information.

In the simulations represented by FIGS. 5-9 the time unit was configured to represent one minute of elapsed time in a realistic system. One thousand simulations were executed with each simulation spanning 250 simulated minutes or steps. Experimental results were aggregated into bins and averaged to arrive at the probabilities of attack success. Several scenarios were considered in the simulations. A simulator such as the simulator 222, was configured with a game construct representing a real system where actions, states and various parameters, for example, the probabilities and payoffs values were based on surveys of actual system administrators and studies of actual enterprise network systems. Some of the many sequences that may be realized in the simulations are depicted in Tables 1-4.

FIG. 5 is a chart of probabilities of successful attacks based on output from a game model simulation representing active participants in an information system. The probability of a successful attacks represented in FIG. 5 was generated based on the parameter modeling set defined with respect to Table 6. FIG. 5 illustrates the probability of successful attacks generated in simulations of the enterprise network 110 at each time interval including 0.13, 0.37, 0.65 and 0.94 in minutes. The probability of successful attacks is plotted for various arrival rates of attacks, for example, by the attacker 104. The arrival rate of an attack refers to the calculated rate possible as determined by the probabilities of an action being taken P(a) and an action being completed successfully P(s). In the example cited, 0.5*0.5 resulting in 0.25 probabilistically. When the simulation was run a 1,000 times and results averaged, the actual determined arrival rates were the values as stated in FIG. 5.

FIG. 6 is a chart of cumulative probabilities of successful attacks based on the same game model simulation output utilized in the chart shown in FIG. 5. The chart in FIG. 6 is based on the same data as used in the chart of FIG. 5, however, a cumulative distribution indicates when the probability of successful attacks reaches 1 for each of the arrival rates of 0.13, 0.37, 0.65 and 0.94 per minute or approximately every 7.7, 2.7, 1.5, and 1 minutes. This particular result may indicate that the attacker 104 has an advantage as the arrival rates of attack increase.

FIG. 7 is a chart depicting probability of confidentiality in an enterprise system based on output from a game model simulation representing active participants in an information system. Confidentiality may be defined as an absence of unauthorized disclosure of information. A measure of confidentiality may comprise a probability that data and information are not stolen or tampered with. FIG. 7 illustrates variation in confidentiality over time for a workstation such as the defender 102's workstation 102 for arrival rates including 0.13, 0.37, 0.65 and 0.94 in minutes as explained above. In another example, confidentiality may be applied to the present model where the confidentiality may be represented as:

C=1−(P_{Fileserver}_{_{—}}_{data}_{_{—}}ₛₜₒₗₑₙ×P_{Worstation}_{_{—}}_{data}_{_{—}}ₛₜₒₗₑₙ) Equation 1

Where C represents confidentiality in the enterprise network 110 and P_{Fileserver}_{_{—}}_{data}_{_{—}}ₛₜₒₗₑₙ and P_{Worstation}_{_{—}}_{data}_{_{—}}ₛₜₒₗₑₙ represent the probability that the attacker 104 succeeded in obtaining data from entities such as the fileserver 128 and defender 102's workstation 102 respectively in the enterprise system 110.

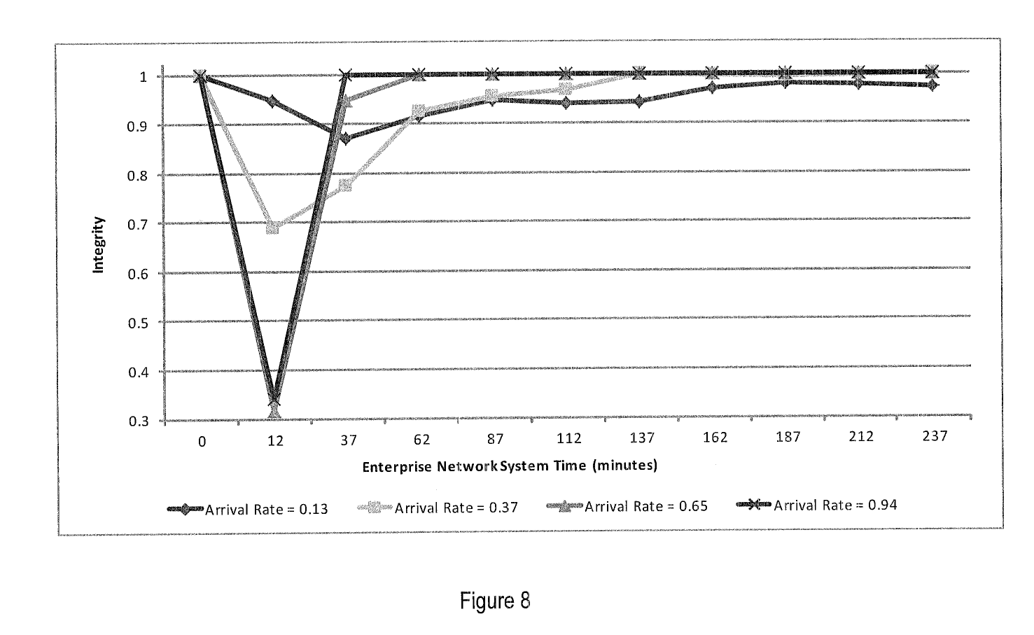

FIG. 8 is a chart depicting probability of integrity in an enterprise system based on output from a game model simulation representing active participants in an information system. Integrity may be defined as the absence of improper system alterations or preventing improper or unauthorized change. Furthermore it may be described as the probability that network services are impaired or destroyed. FIG. 8 illustrates integrity dynamics of the probability that a particular website is defaced over time for the attack arrival rates of 0.13, 0.37, 0.65 and 0.94 in minutes. As shown in FIG. 8, the arrival rate of attacks has a significant effect on the dynamics of the probability of the particular website being defaced. In another example, integrity may be represented as:

I=1−(P_{Website}_{_{—}}_{defaced}×P_{Webserver}_{_{—}}_{DOS}) Equation 2

Where I represents integrity in the enterprise network 110, and P_{Website}_{_{—}}_{defaced} and P_{Webserver}_{_{—}}_{DOS} denote the probability in our model that the attacker succeeded in defacing a Website or running a denial of service (DOS) virus and/or shutting down the enterprise network 110 utilizing the actions Deface_website_leave, and Run_DOS_virus.

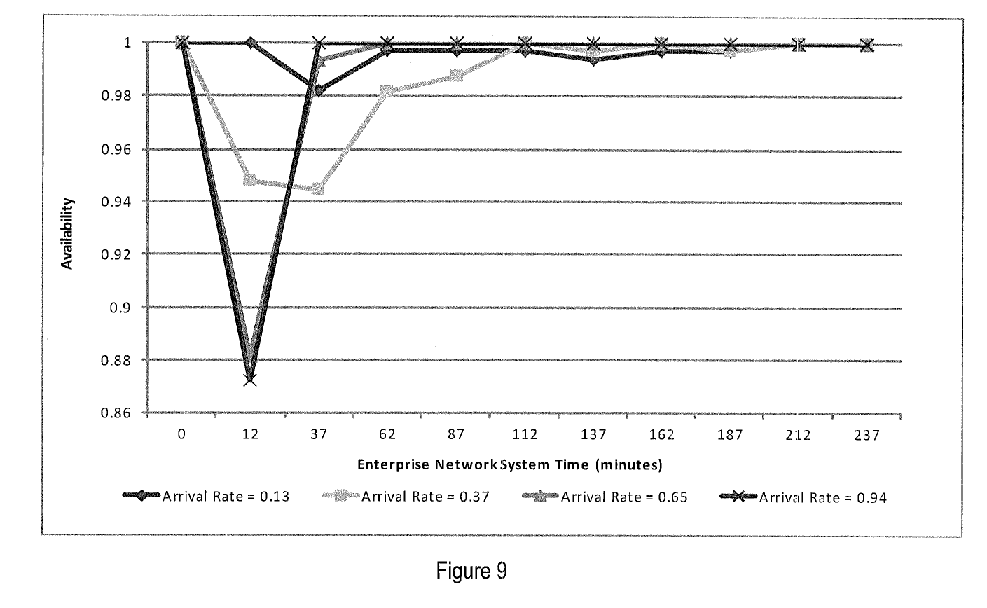

FIG. 9 is a chart depicting probability of availability in an enterprise system based on output from a game model simulation representing active participants in an information system. Availability may be defined as a system being available as needed or computing resources which may be accessed by authorized users at any appropriate time. Availability may further be described as whether authorized users can access information in a system considering the probability that the network services are impaired or destroyed. FIG. 6 illustrates availability based on the probability of the Run_DOS_virus action occurring for attack arrival rates of 0.13, 0.37, 0.65 and 0.94 in minutes.

Furthermore, availability may be expressed as:

A=1−(P_{Webserver}_{_{—}}_{DOS}×P_{Network}_{_{—}}ₛₕᵤₜ_{_{—}}_{down}) Equation 3

Where A represents availability in the enterprise network 110, P_{Webserver}_{_{—}}_{DOS} denotes the probability that the attacker 104 succeeded in successfully running a DOS virus in the Webserver 128 utilizing the action Run_DOS_virus, and P_{Network}_{_{—}}_{Network}_{_{—}}ₛₕᵤₜ_{_{—}}_{down} represents the probability of shutting down the enterprise network 110 using the Shutdown_Network action.

Referring to FIGS. 7-9 it may be seen that on average, levels of confidentiality, integrity, and availability decrease at the beginning of a simulation and then increase over time, as the defender recovers from the attack. Therefore, it may be crucial to the safety of an enterprise system represented by the enterprise system 110, that an administrator of the system be able to discover an attack as early as possible.

The computer system 210 may be preprogrammed with a series of instructions that, when executed, may cause the processor 202 of the computer system 210 to perform the method steps of:

a. providing an attacker agent having a number of actions in a system with each action having a probability of attempting the action value, a probability of success of the action value, a payoff value, an initial state value and a final state value;

b. providing a defender agent having a number of actions in a system with each action having a probability of attempting the action value, a probability of success of the action value, a payoff value, an initial state value and a final state value; and

c. performing an action by each of the attacker and defender to change a system state of the system, wherein the performing step may be performed once for a unit of time.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A computer implemented method for quantitatively predicting vulnerability in security of an information system, which is operable to receive malicious actions against security of the information system and is operable to receive corrective actions relative to the malicious actions for restoring security in the information system, the method comprising:
constructing a game oriented agent based model which represents security activity in the information system in a simulator application, wherein the game oriented agent based model is constructed as a game having two opposing participants including an attacker and a defender, a plurality of probabilistic game rules and a plurality of allowable game states;
running the simulator application comprising the constructed game oriented agent based model representing security activity in the information system, for a specified number of simulation runs and reaching a probabilistic number of the plurality of allowable game states in each of the simulation runs, wherein the probability of reaching a specified one or more of the plurality of allowable game states in each of the simulation runs is unknown prior to running each of the simulation runs; and
collecting data which is generated during one or more of the plurality of allowable game states and for one or more of the specified simulation runs to determine a probability of one or more aspects of security in the information system.

2. The computer implemented method of claim 1, wherein a current game state is determined based on probabilistic activity of a prior game state.

3. The computer implemented method of claim 1 further comprising, providing in the constructed game oriented agent based model representing the security activity in the information system, one or more allowable defender actions for the defender, each of the allowable defender actions having a corresponding probability of execution and a corresponding probability of success in execution in instances when the allowable defender action is executed for at least one of the one or more of the allowable game states, and one or more allowable attacker actions for the attacker, each allowable attacker action having a corresponding probability of execution and corresponding probability of success in execution in instances when the allowable attacker action is executed, for at least one of the one or more allowable game states.

4. The computer implemented method of claim 1 further comprising assigning, in the constructed game oriented agent based model representing the security activity in the information system, a payoff value to each of said one or more allowable defender actions and to each of said one or more allowable attacker actions, wherein each of the payoff values indicates a score for successful execution of its corresponding allowable defender action or of its corresponding allowable attacker action.

5. The computer implemented method of claim 4, wherein each of the payoff values corresponding to an allowable defender action represents a time delay for successfully executing the allowable defender action.

6. The computer implemented method of claim 1 further comprising qualifying, in the constructed game oriented agent based model representing the security activity in the information system, at least one of said game states as a beginning state, one or more of said game states as an end state and one or more of said game states as a target state.

7. The computer implemented method of claim 6 wherein each of the one or more simulation runs stops running after reaching one of said one or more game states qualified as an end state or after performing a specified number of steps in said each of the one or more simulation runs.

8. The computer implemented method of claim 6 wherein for each of the one or more simulation runs, one or both of:
collecting data at one or more steps of the simulation run; and
determining statistical information at one or more of the target states of the simulation run;
wherein the probability of the one or more aspects of security in the information system comprises a probability of confidentiality, integrity or availability in the information system or probability of successful attacks in the information system.

9. The computer implemented method of claim 1 further comprising assigning a time increment for each step in said simulation application.

10. A system for quantitatively predicting vulnerability in security of an information system, the system comprising one or more processors or circuits, wherein for the information system, which is operable to receive malicious actions against security of the information system and is operable to receive corrective actions relative to the malicious actions for restoring security in the information system, said one or more processors or circuits is operable to:
construct a game oriented agent based model which represents security activity in the information system in a simulator application, wherein the game oriented agent based model is constructed as a game having two opposing participants including an attacker and a defender, a plurality of probabilistic game rules and a plurality of allowable game states;
run the simulator application comprising the constructed game oriented agent based model representing security activity in the information system, for a specified number of simulation runs and reaching a probabilistic number of the plurality of allowable game states in each of the simulation runs, wherein the probability of reaching a specified one or more of the plurality of allowable game states in each of the simulation runs is unknown prior to running each of the simulation runs; and
collect data which is generated during one or more of the plurality of allowable game states and for one or more of the specified simulation runs to determine a probability of one or more aspects of security in the information system.

11. The system according to claim 10, wherein a current game state is determined based on probabilistic activity of a prior game state.

12. The system according to claim 10, wherein said one or more processors or circuits is operable to provide in the constructed game oriented agent based model representing the security activity in the information system, one or more allowable defender actions for the defender, each of the allowable defender actions having a corresponding probability of execution and a corresponding probability of success in execution in instances when the allowable defender action is executed for at least one of the one or more of the allowable game states, and one or more allowable attacker actions for the attacker, each allowable attacker action having a corresponding probability of execution and corresponding probability of success in execution in instances when the allowable attacker action is executed, for at least one of the one or more allowable game states.

13. The system according to claim 10, wherein said one or more processors or circuits is operable to assign in the constructed game oriented agent based model representing the security activity in the information system, a payoff value to each of said one or more allowable defender actions and to each of said one or more allowable attacker actions, wherein each of the payoff values indicates a score for successful execution of its corresponding allowable defender action or of its corresponding allowable attacker action.

14. The system according to claim 11, wherein each of the payoff values corresponding to an allowable defender action represents a time delay for successfully executing the allowable defender action.

15. The system according to claim 10, wherein said one or more processors or circuits is operable to qualify in the constructed game oriented agent based model representing the security activity in the information system, at least one of said game states as a beginning state, one or more of said game states as an end state and one or more of said game states as a target state.

16. The system according to claim 15, wherein each of the one or more simulation runs stops running after reaching one of said one or more game states qualified as an end state or after performing a specified number of steps in said each of the one or more simulation runs.

17. The system according to claim 15, wherein for each of the one or more simulation runs, said one or more processors or circuits is operable to one or both of:
collect data at one or more steps of the simulation run; and
determine statistical information at one or more of the target states of the simulation run;
wherein the probability of the one or more aspects of security in the information system comprises a probability of confidentiality, integrity or availability in the information system or probability of successful attacks in the information system.

18. The system according to claim 10, wherein said one or more processors or circuits is operable to assign a time increment for each step in said simulation application.

19. A non-transitory computer-readable medium comprising a plurality of instructions executable by a processor for quantitatively predicting vulnerability in security of an information system, wherein for the information system, which is operable to receive malicious actions against security of the information system and is operable to receive corrective actions relative to the malicious actions for restoring security in the information system, the non-transitory computer-readable medium comprises instructions for:
constructing a game oriented agent based model which represents security activity in the information system in a simulator application, wherein the game oriented agent based model is constructed as a game having two opposing participants including an attacker and a defender, a plurality of probabilistic game rules and a plurality of allowable game states;
running the simulator application comprising the constructed game oriented agent based model representing security activity in the information system, for a specified number of simulation runs and reaching a probabilistic number of the plurality of allowable game states in each of the simulation runs, wherein the probability of reaching a specified one or more of the plurality of allowable game states in each of the simulation runs is unknown prior to running each of the simulation runs; and
collecting data which is generated during one or more of the plurality of allowable game states and for one or more of the specified simulation runs to determine a probability of one or more aspects of security in the information system.

20. The non-transitory computer readable medium of claim 19, wherein a current game state is determined based on probabilistic activity of a prior game state.

21. The non-transitory computer readable medium of claim 19 further comprising, providing in the constructed game oriented agent based model representing the security activity in the information system, one or more allowable defender actions for the defender, each of the allowable defender actions having a corresponding probability of execution and a corresponding probability of success in execution in instances when the allowable defender action is executed for at least one of the one or more of the allowable game states, and one or more allowable attacker actions for the attacker, each allowable attacker action having a corresponding probability of execution and corresponding probability of success in execution in instances when the allowable attacker action is executed, for at least one of the one or more allowable game states.

22. The non-transitory computer readable medium of claim 19 further comprising assigning, in the constructed game oriented agent based model representing the security activity in the information system, a payoff value to each of said one or more allowable defender actions and to each of said one or more allowable attacker actions, wherein each of the payoff values indicates a score for successful execution of its corresponding allowable defender action or of its corresponding allowable attacker action.

23. The non-transitory computer readable medium of claim 22, wherein each of the payoff values corresponding to an allowable defender action represents a time delay for successfully executing the allowable defender action.

24. The non-transitory computer readable medium of claim 19 further comprising qualifying, in the constructed game oriented agent based model representing the security activity in the information system, at least one of said game states as a beginning state, one or more of said game states as an end state and one or more of said game states as a target state.

25. The non-transitory computer readable medium of claim 24 wherein each of the one or more simulation runs stops running after reaching one of said one or more game states qualified as an end state or after performing a specified number of steps in said each of the one or more simulation runs.

26. The non-transitory computer readable medium of claim 24 wherein for each of the one or more simulation runs, one or both of:
collecting data at one or more steps of the simulation run; and
determining statistical information at one or more of the target states of the simulation run;
wherein the probability of the one or more aspects of security in the information system comprises a probability of confidentiality, integrity or availability in the information system or probability of successful attacks in the information system.

27. The non-transitory computer readable medium of claim 19 further comprising assigning a time increment for each step in said simulation application.
